(19) United States
(12) Patent Application Publication
(10) Pub. No.: US 2026/0284886 A1
(43) Pub. Date: Sep. 24, 2026

(54) ARTICULATED-ARM ROBOT AND METHOD FOR MONITORING AN ARTICULATED-ARM ROBOT

(71) Applicant: BIZLINK ROBOTIC SOLUTIONS FRANCE S.A.S., Gellainville (FR)

(72) Inventors: Jerome CHEMOUNY, Saint Remy Les Chevreuse (FR); Cyril MAURIER, Villebon sur Yvette (FR); Peter STEINER, Chatillon (FR)

(21) Appl. No.: 19/672,989

(22) Filed: May 11, 2026

Related U.S. Application Data
(63) Continuation of application No. PCT/EP2024/081582, filed on Nov. 7, 2024.

(30) Foreign Application Priority Data
Nov. 10, 2023 (DE) 10 2023 211 163.2

(51) Int. Cl. B25J 9/16; B25J 19/06

(52) U.S. Cl. CPC B25J 9/1674; B25J 9/1694; B25J 19/066

(57) ABSTRACT

The articulated-arm robot has a plurality of articulated robot links each driven by an electric motor. Two independent monitoring devices, namely, a first monitoring device and a second monitoring device, have one movement sensor each, namely, a first and a second movement sensor for detecting a momentary position of the respective robot link. Each monitoring device has a device for detecting a force momentarily acting on the robot link, namely, a first and a second force sensor, wherein the two force sensors are based on different measuring principles. Each monitoring device has an evaluation unit, namely, a first evaluation unit for processing data of the first movement sensor and of the first force sensor and a second evaluation unit for processing data of the second movement sensor and the second force sensor. The articulated-arm robot is redundantly monitored via two separate monitoring paths.

### CROSS-REFERENCE TO RELATED APPLICATION

This application is a continuation, under 35 U.S.C. § 120, of copending International Patent Application PCT/EP2024/081582, filed November 7, 2024, which designated the United States; this application also claims the priority, under 35 U.S.C. § 119, of German Patent Application DE 10 2023 211 163.2, filed November 10, 2023; the prior applications are herewith incorporated by reference in their entirety.

### FIELD AND BACKGROUND OF THE INVENTION

The invention relates to an articulated-arm robot with a plurality of robot links which are attached to one another by in each case one articulation and are driven by electric motors, wherein the articulated-arm robot is designed for redundant monitoring of its operation.

Such an articulated-arm robot is known from European Patent EP 1 445 075 B2 and its counterpart US Patent No. US 7,086,293 B2, for example.

An articulated-arm robot generally has a plurality of robot links which are attached to one another by in each case one articulation. The distinct robot links form an articulated chain and are mounted to one another via the articulations so that each robot link can carry out a rotational movement with respect to its adjacent robot link. The respective rotational movement is controlled by in each case one electric motor which is, for example, arranged immediately within the articulation. For example, a shaft of the motor is in parallel to an articulation axis.

Especially with articulated-arm robots which come into contact or within immediate vicinity of persons, especially with medical robots which work on patients, e.g., highly precise positioning and reliable undisturbed operation of the robot and its movements are important to prevent any risk to the persons.

In the above-mentioned EP 1 445 075 B2 and US 7,086,293 B, within the context of a redundant measuring system, a plurality of different physical measured quantities are determined and compared to one another. In particular, a strain of a structure of the robot, position data and the motor current are evaluated.

### SUMMARY OF THE INVENTION

Based on this, it is an object of the invention to provide an articulated-arm robot, in particular for medical applications, and a method for monitoring such an articulated-arm robot, wherein high functional reliability is ensured.

With the above and other objects in view there is provided, in accordance with the invention, an articulated-arm robot with a plurality of robot links which are connected to one another by in each case one articulation joint and are each driven by an electric motor, wherein the articulated-arm robot is designed for redundant monitoring of its operation. To this end, two independent monitoring devices, i.e. a first and a second monitoring device are designed and each of the monitoring devices has the following elements:
in each case one movement sensor, i.e. a first and a second movement sensor for detecting a momentary position and in particular also a momentary speed of the respective robot link,
in each case one device for detecting a force momentarily acting on the robot link and also a force moment, i.e. a first and a second device, wherein the two devices are based on different measuring principles, and
in each case one evaluation unit, i.e. a first evaluation unit for processing data of the first movement sensor and data of the first device and a second evaluation unit for processing data of the second movement sensor and data of the second device. The two evaluation units are in particular designed so as to be independent and fully separate from one another and are formed by two distinct building units, for example. Each one of the evaluation units is suitably adapted for evaluating and data processing and in each case has a computer unit, in particular a microchip, a memory and an executable program for processing and evaluating the data.

According to the invention, furthermore, the object is attained by a method for monitoring a multi-axis articulated-arm robot which is monitored by means of the two previously described monitoring devices during operation. The advantages and preferred adaptations recited below with regard to the articulated-arm robot may analogously also be applied to the method.

It should be emphasized that the monitoring is carried out by means of two monitoring devices independent and separate from one another so that the operation of the articulated-arm robot is monitored reliably and redundantly.

Preferentially, the articulated-arm robot generally has a redundantly designed system for recognizing a collision.

It is of particular importance that a respective monitoring device in each case evaluates movement data and momentary data on force action. Especially evaluation of data with regard to the force momentarily acting on the robot link or with regard to a momentarily acting force moment is of particular importance especially in medical robots in order to immediately recognize collisions and, as appropriate, instantaneously stop the movement. This device for detecting the momentary force is a part of the system for recognizing collisions.

Preferably, a respective evaluation unit is configured to in particular collectively evaluate movement or position data momentarily detected via the respective movement sensor and data momentarily detected via the respective device on the acting force with regard to any potential collision of the articulated-arm robot with an object. This preferentially involves mutual verification or review of the movement data detected by the respective movement sensor with those data detected by the device for detecting the force. The two datasets are therefore collectively leveraged for collision checking and collision monitoring. This already constitutes redundant checking as two different datasets are leveraged and are in particular verified mutually. Mutual verification avoids false notifications. At the same time, provision of two distinct datasets enables reliable collision detection, preferably even if one of the two detection devices fails. That is, preferably, both based on the movement data and based on the data on the acting force, independently of one another, conclusions may be drawn as to a risk of collision. That is, within each one of the monitoring devices, such redundant data capture is already implemented once by the movement sensor and once by the device for detecting the force.

To achieve particularly high redundant reliability, presently, two different devices for detecting the momentarily acting force are arranged for the two monitoring devices. This means that the momentarily acting force is determined by two different measuring principles. Choosing different measuring principles further increases operational reliability.

Using different measuring principles is understood to mean that the two devices evaluate different physical measured quantities which allow conclusions as to the momentarily exerted force.

Thus, for example, according to a preferred adaptation, the momentarily exerted force is immediately determined by a force measuring device, especially by a suitable direct force sensor, for example a load cell.

According to another action principle, a deformation, for example a strain or compression of a structural member of the articulated-arm robot, especially a deformation of the robot link, is detected. Mechanical forces acting on the robot link regularly lead to mechanical deformation of the robot link which are detectable, wherein the deformations enable conclusions as to the momentary force. Consequently, this measuring principle provides suitable strain sensors for measuring the deformation. This may be, for example, by using optical sensors, especially optical waveguides. With optical waveguides, a strain of the same is detected. In particular, optical waveguides are fastened immediately to the robot link and are deformed along with it. Alternatively, preferably at least one and preferentially a plurality of strain gauges are fixed to the robot link.

According to a further measuring principle, for example, there is the possibility of evaluating a motor current of the electric motor which generates the movement of the robot link. This is because, if there is a mechanical force acting on the robot link, this leads to a measurable change in the motor current.

With regard to ensuring operational reliability, the two monitoring devices evaluate the data obtained, therefore the movement data and the force data. As soon as one of the monitoring devices determines a critical operating state, it initiates a safety measure, for example stopping the movement of the articulated-arm robot or returning to a safe operating position. Preferably, furthermore, the evaluated data of the two monitoring devices is compared to one another. To this end, they may be in communication connection to one another or even to a higher-level control unit.

According to a preferred adaptation, the first monitoring device has at least one strain sensor fixed to the robot link which is in particular designed as a strain gauge. This strain sensor forms the first device for detecting the force momentarily acting on the robot link or the momentarily acting force moment. Appropriately, a plurality of strain sensors, especially strain gauges, are fixed about the circumference of the articulated-arm robot so that any deformations in different directions are reliably recognized.

Alternatively or optionally complementarily to the at least one strain sensor, a force measuring device, as described previously, is arranged as the first device for detecting the momentary force. In particular, this force measuring device is fixed between a final robot link, in particular between what is known as the robot hand, and a processing tool (end effector) fastened thereto. Depending on the case of application, this may be different end effectors. In medical applications, it may be, for example, a patient couch which may be used, for example, to displace the patient into a therapeutic or diagnostic assembly, or a diagnostic or therapeutic equipment (e.g., irradiation equipment) which is displaced relative to the patient, or even a medical instrument for treating the patient.

In a preferred adaptation, the second monitoring device has a current sensor for determining the motor current of the motor which is used to drive the robot link. This current sensor forms the second device for detecting the force momentarily acting on the robot link or the momentarily acting force moment. From the measured momentary motor current, the momentarily acting force or the momentarily acting force moment is then inferred in a manner known per se.

In particular the combination of the use of strain sensors or a force measuring device with the evaluation of the motor current enables high operational reliability of the articulated-arm robot.

Preferentially, the two movement sensors are encoders which are used to detect a rotational movement of a shaft of the motor. Such encoders ensure reliable position detection of the momentary position of the robot. Complementarily, the momentary speed can usually also be derived from the data of such encoders. Layout and action of such encoders are known in principle.

According to a preferred adaptation, the data detected by the movement sensors is also leveraged for recognizing collisions. To this end, the data detected by the movement sensors is evaluated, e.g., with regard to the momentary position and/or speed and/or acceleration and these determined quantities are evaluated with regard to a potential collision.

Independently of the evaluation with regard to collisions, the data of the movement sensors is leveraged for determining the momentary position and/or speed and/or acceleration, wherein this data is preferentially used for open-loop control and closed-loop control of the movements of the articulated-arm robot.

In a preferred adaptation, the movement sensors are arranged at different locations, that is, the first movement sensor is arranged remote from the second movement sensor. This favors independent detection of the momentary movement data.

In particular, this provides that the movement sensors are fixed on opposing sides of the electric motor. Especially, the first movement sensor is fixed to an input side of the motor, in particular at an input-side shaft, and the second movement sensor is fixed to an output side, in particular at an output shaft of the motor. The monitoring robot link is driven via the output shaft. Typically, this is by interposing a transmission. The second movement sensor is preferentially arranged downstream of the transmission.

With regard to detection of the movement data being as independent as possible, moreover, the two movement sensors are also designed differently. This also further improves operational reliability. Both for detecting the movement data and for detecting the force data, different measuring principles are consequently employed for the two monitoring devices so that high redundant protection is achieved specifically by using different measuring principles.

Especially, this provides that the one movement sensor, for example the first or the second movement sensor, is designed as an incremental encoder and hence as an incremental transducer, and the other movement sensor, therefore the second or the first movement sensor, is designed as an absolute encoder and hence as an absolute-value transducer.

Alternatively or complementarily, the two encoders also differ with regard to the number of reading heads. In such encoders, such reading heads detect a movement, especially a rotational movement. Preferably, the one encoder only has one, and the other encoder has two reading heads.

In an appropriate adaptation, a plurality of, and in particular all of, the robot links are associated with in each case a first and a second movement sensor and a first and a second device, as have been described previously. The data of all first movement sensors and the data of all first devices is evaluated by the first evaluation unit and the data of all second movement sensors and second devices is evaluated by the second evaluation unit. This measure forms two fully separate monitoring paths which are in particular also based on different measuring principles for detecting both the movement data and the force data.

Preferably, the two evaluation units are designed differently. That is, at least some and preferentially all of the components of the evaluation units differ from one another. Alternatively or complementarily, the two evaluation units originate from different manufacturers.

For data communication and data transmission between individual components, a bus system (data bus) is preferably employed, that is, data transmission is according to a specified data protocol. Preferably, different bus systems are employed in the articulated-arm robot, in particular, the data connection to the evaluation units is via two distinct bus systems. Preferentially, one of the bus systems is based on an Ethernet protocol, and the other bus system is based on a non-Ethernet protocol. For example, the other bus system is designed for serial data transmission and is preferably based on an EIA-xxx standard (also referred to as an RS-xxx standard). Especially, the other bus system is based on the EIA-485 standard.

Preferably, furthermore, a respective drive unit and hence a respective motor is associated with a redundant braking device with two brakes which are in each case designed for exerting a currentless braking force, wherein the two brakes are preferably based on different action principles so that the respective braking force of the two brakes is exerted by distinct action principles.

This is understood to mean that the forces for generating the braking force are generated by different physical measures. For example, the different action principles are based on exertion of a magnetic force, a pneumatic force, a hydraulic force, or a mechanical spring force.

Such a braking device is described in detail in our German published patent application DE 10 2023 211 164 entitled “Gelenkarmroboter,” the priority of which is claimed in the instant application. The German application is hereby incorporated by reference, with special emphasis on the illustrations in FIGS. 2 and 3, and the description thereof.

A respective brake regularly has two braking partners, i.e. in particular one movable and one fixed braking partner, wherein the braking force or a braking torque is suitably transmitted from the fixed braking partner to the other braking partner.

Usually, the two braking partners are mechanically pressed against each other to generate the braking force so that the braking action is generated by friction of the two braking partners. This pressing force, which elicits the braking force, is in particular generated by in each case one of the action principles mentioned above.

By using different action principles, risk of failure is reduced and thereby functional reliability is increased.

In a preferred adaptation, the one brake is a spring force-actuated brake in which, therefore, the braking force is generated by a spring force. The two braking partners are pressed against each other by a spring force.

In a preferred further development, the other brake is a magnetic brake in which the braking force is generated by magnetic force.

In a preferred adaptation, a permanent magnet is leveraged to this end. Preferably, similarly to the spring force-actuated brake, the one braking partner is pressed against the other braking partner by the magnetic force.

The two currentless brakes permanently exert a force on the braking partners due to the action principles which leads to the braking action. In order to control the braking action during normal operation, in a preferred adaptation, each brake is associated with an electromagnet via which the braking force of the respective brake is controllable and via which a respective brake may be transitioned to an open position. Consequently, an electrically controlled magnetic force is generated via the electromagnet which in each case acts on one of the braking partners. The electrically controlled force counteracts the permanent and currentlessly generated force. Consequently, this electromagnet makes the braking force meterable and in particular makes the braking action fully removable.

In a preferred adaptation, the brakes are fixed to a shaft of the drive unit. The braking force consequently in each case acts on the shaft of the drive unit.

Preferably, at least one of the brakes has, and preferentially both brakes in each case have, a brake disk moving along the shaft which cooperates with a stationary brake disk fixedly attached to the shaft. The moving brake disk and the stationary brake disk are the two braking partners of the respective brake. The currentless force acts on the moving brake disk, more precisely in a direction towards the stationary brake disk. The action of the previously described electromagnet is opposed so that therefore, the moving brake disk is pulled away from the stationary brake disk by the electromagnet upon activation thereof. The moving brake disks are mounted on the shaft of the motor or otherwise slidingly, for example.

The stationary brake disk is mechanically fixedly attached to the shaft, for example, via a fastening flange or via a welded attachment. Preferably, however, the stationary brake disk is a monolithic segment of at least one part of the shaft.

In a preferred adaptation, the stationary brake disk is arranged between the two moving brake disks. The stationary brake disk consequently forms a joint brake disk of the two brakes.

Preferably, the shaft of the drive unit is designed as a hollow shaft at least in the region of the brakes. This in particular provides an additional inner cavity which is utilizable. In a preferred adaptation, the shaft is designed as a hollow shaft only in the region of the brakes. In this case, the hollow shaft is attached to at least one further portion of the shaft (which is in particular not designed as a hollow shaft) in a rotationally fixed manner via a flange attachment or even a welded attachment, for example. Alternatively, the entire shaft of the drive unit is designed as a hollow shaft.

In an appropriate adaptation, the electric lines are passed through the hollow shaft which are attached to the electromagnet. These electric lines serve to control the electromagnet.

Moreover, the hollow shaft also offers the possibility of integration of further functions such as, for example, arrangement or adaptation of sensors, of cooling elements, etc.

The drive unit has in each case one output shaft via which the adjustment movements of the respective robot link are actuated. Apart from the electric motor, the drive unit usually also has a transmission which is downstream of the motor.

Different variants for positioning are available for the two brakes:

According to a preferred embodiment variant, the two brakes are arranged jointly on one side of the motor. For example, on the input side, therefore opposing the output shaft and in particular also opposing the transmission. Alternatively, the two brakes are arranged jointly on the output side, therefore downstream of the motor, wherein they are preferably positioned between the motor and the transmission.

As an alternative to joint positioning on one side of the motor, the two brakes are arranged spaced apart from one another on opposing sides of a component of the drive unit. Especially, they are positioned on opposing sides of the motor or, alternatively, on opposing sides of the transmission. Preferably, one of the brakes is positioned on the input side of the motor, and the other brake is positioned on the output side of the motor and especially between the motor and the transmission.

In a preferred adaptation, the respective brake is associated with two redundant position sensors for detecting the momentary position of the respective brake. This redundancy ensures reliable detection. Preferably, the two position sensors are designed differently. This ensures high failure safety. For example, the two position sensors are based on different (physical) action principles and/or are connected so as to be opposed so that the one sensor is closed while in the normal state and the other sensor is open while in the normal state.

Furthermore, according to the invention, the object is attained by an articulated-arm robot having a redundantly adapted system for its operation. The respective redundantly adapted system has a plurality of system components. According to a further aspect according to the invention, to ensure high failure safety, the two redundant systems are generally designed differently in relation to one another.

This basic design principle of designing redundant systems not identically but differently accomplishes high failure safety so that, for example, construction errors, programming errors, etc. which may lead to a failure in the one redundant system cannot occur in the other, differently designed system due to its construction. Systems designed not identically are understood to mean that at least system components of the two systems in each case having the same function and hence being redundant are designed differently. Preferably a plurality of, and in particular all of, the system components of the two systems having the same function are designed differently.

In a preferred adaptation, the differently designed system components are based on different action principles, as has been explained further previously, for example, in conjunction with the braking device, with the movement sensors and/or with the devices for detecting the momentarily acting force, for example.

Alternatively or complementarily, the distinct system components differ in that they originate from different manufacturers, for example.

In particular, it is also provided complementarily that the articulated-arm robot is associated with a redundant controller and/or a redundant evaluation unit, as has already been explained previously. The articulated-arm robot is controlled via the control unit. Appropriately, such control units and/or evaluation units are also redundantly adapted and also preferentially different from one another. This means that the individual components such as, for example, the hardware and/or the software are designed differently. Complementarily or alternatively, the software and/or the hardware originate from different manufacturers.

Preferably a plurality of system components and preferentially all of the system components of the two redundant systems are designed differently in relation to one another. This ensures high, fail-safe redundancy overall.

This basic principle is not limited to the application with an articulated-arm robot but may generally be applied to apparatus and machines.

The system components are in particular at least one, a plurality of or all of the components already explained previously, especially
the redundantly adapted braking device with the two brakes which are based on different action principles,
the redundant monitoring of the operation of the articulated-arm robot with two monitoring devices which differ from one another,
different control or evaluation units,
differently designed movement sensors for detecting a momentary position of the respective robot link,
different devices for detecting a force momentarily acting on the robot link,
different position sensors for detecting positions of parts of a braking device,
different bus systems for data transmission.

Other features which are considered as characteristic for the invention are set forth in the appended claims.

Although the invention is illustrated and described herein as embodied in an articulated-arm robot and method for monitoring an articulated-arm robot, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 shows a simplified side view of an articulated-arm robot;

FIG. 2 shows a schematized block diagram representation of an articulated-arm robot with two independent monitoring devices;

FIG. 3 shows a schematized block diagram representation of sections of an articulated-arm robot with two independent monitoring devices according to an alternative embodiment variant;

FIGS. 4, 5 show alternative variants of an articulated-arm robot; and

FIG. 6 shows a simplified side view of a drive unit with a braking device with two differently adapted brakes.

### DETAILED DESCRIPTION OF THE INVENTION

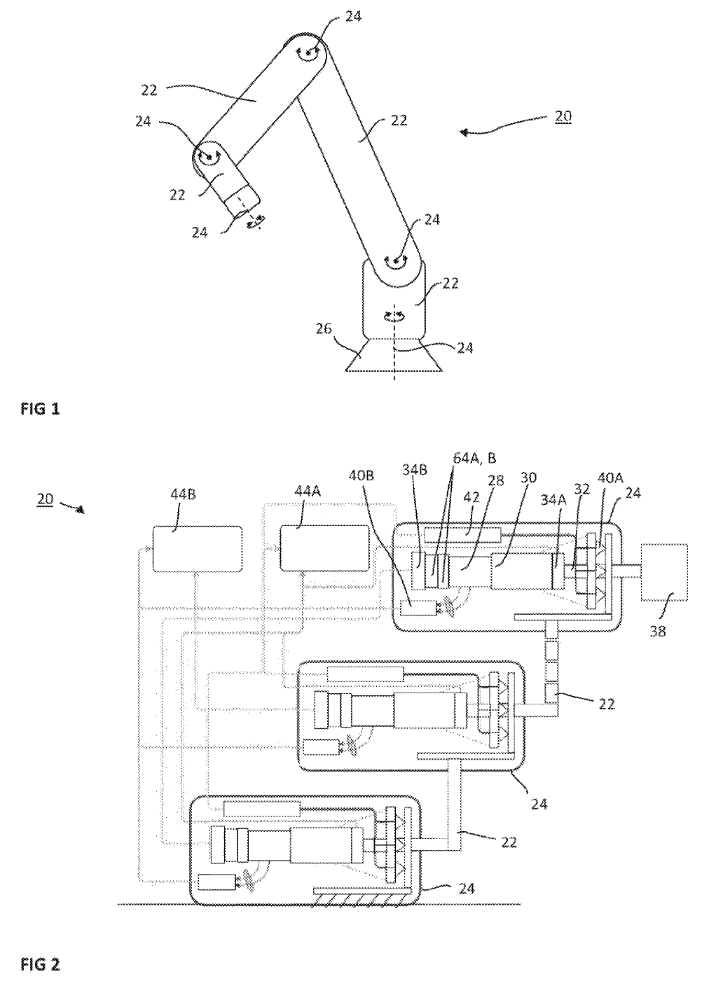

FIGS. 1 and FIG. 4 and FIG. 5 each represent an articulated-arm robot 20 which is in particular employed as a medical robot for medical applications. The articulated-arm robot 20 is a multi-axis robot with a plurality of robot links 22 which are in each case attached to one another via articulations 24.

In the embodiment, as an example, the articulated-arm robot 20 has a pedestal 26 where a base is arranged as a first robot link 22 rotatable about a vertical rotational axis via a first articulation or joint 24. There, as a second robot link 22, a swing arm is pivotable about a horizontal axis about a second articulation 24. At an end side of the swing arm, as a further robot link 22, a robot arm is rotatably mounted about a third articulation 24. At the robot arm, finally, as a further robot link 22, a robot hand is in turn rotatably mounted about a further articulation 24. At its front end, it has a rotatable fastening flange which serves to fasten a tool. For a medical robot, this may be a medical instrument or even a patient couch, for example.

During operation, the individual robot links 22 are adjusted relative to one another about the respective articulations 24. To this end, each articulation is allocated an individual electric drive unit for exerting the adjustment movement. The articulated-arm robot 20 is generally energized via a control unit not represented further herein.

Complementarily or as an alternative to rotational adjustment about a rotational axis, at least one robot link 22 is also adjustable in a translational manner. This is done in particular using an additional translational drive unit or using a combined drive unit which is designed for exerting both a rotational movement and a translational movement. FIG. 5 shows an embodiment variant in which a robot link 22 (right half of the image) is translationally displaceable along a guide, for example.

With such articulated-arm robots 20, the movement sequence is monitored for safety reasons. In particular for articulated-arm robots 20 which work in proximity of persons or even on patients, as is the case for medical robots, high functional reliability must be ensured.

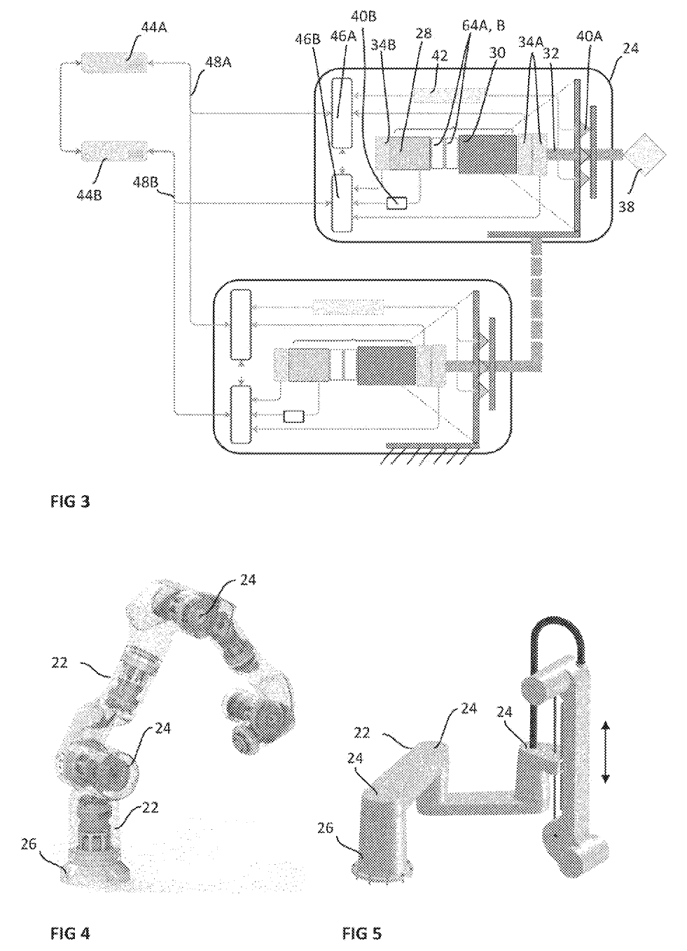

In conjunction with FIGS. 2 and FIG 3 , explained further below are the monitoring of the operation of the articulated-arm robot 20 and the devices required to this end:

With the articulated-arm robot 20 shown in FIGS. 2 and FIG 3 in a simplified block diagram representation, the individual articulations 24 are represented in a schematized manner by boxes in which a plurality of components are shown. In turn, the articulations 24 are attached to one another by robot links 22 represented in a simplified manner. In the embodiment, only three articulations 24 are represented in total.

In the particular implementation, distinct components are typically arranged within a respective articulation 24.

In particular, this relates in each case to an electric motor 28 which is adjoined by a transmission 30 on its output side. The respective robot link 22 is driven via an output shaft 32.

On the output side, downstream of the transmission 30, a first encoder 34A is fixed as a first movement sensor. This detects the movement of the output shaft 32 in order to determine the position and/or speed of the respective robot link 22. In the variant according to FIG. 3, this first encoder 34A is represented by two boxes which illustrate an adaptation with two reading heads.

According to FIG. 2, on the input side of the motor 28 opposing the transmission 30, a braking device with two redundant brakes 64A, B and a second encoder 34B as a second movement sensor are fixed to an incoming shaft of the motor 28 not represented further herein. In the variant according to FIG. 3, it preferably has only one reading head. Furthermore, in this embodiment variant, the braking device with the two brakes 64A, B is arranged between the motor 28 and the transmission 30.

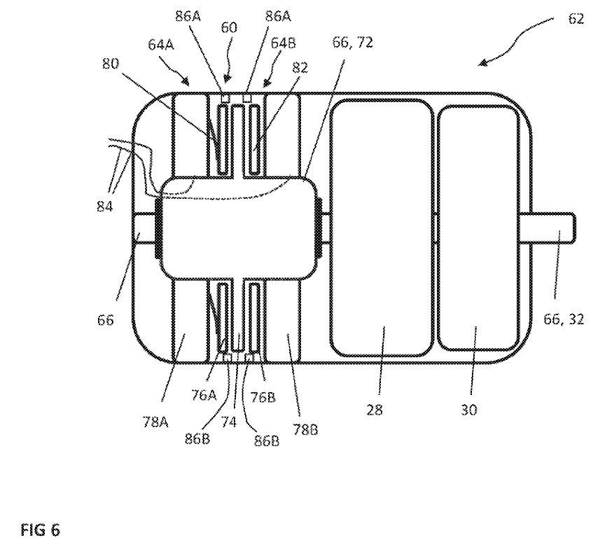

Motor 28, transmission 30, output shaft 32 and the braking device, along with the encoders 34A, 34B, form a respective drive unit 62 (cf. FIG. 6). A tool 38 is fastened to the final articulation 24, typically via a fastening flange.

The two encoders 34A, 34B are preferentially designed differently, wherein preferably, the one encoder 34A is designed as an incremental encoder 34A and the encoder 34B is designed as an absolute encoder 34B. While the incremental encoder 34A only detects and forwards relative changes in position, the absolute encoder 34B provides absolute positions of the robot link 22 as measurement results.

Within the box representative of the articulation 24, as an example, structural members of the robot link 22 are furthermore represented in a schematized manner, wherein strain gauges 40A are fixed thereto as the strain sensor which form a first device for detecting a force acting on the respective robot link 22. In the embodiment, as an example, three strain gauges 40A are represented in a schematized manner by triangles. In the embodiment, the strain gauges 40A are attached to an associated readings recorder 42. Alternatively or complementarily, in an alternative embodiment, a force measuring device is arranged as the first device or as a further first device for detecting the momentary force. The force measuring device is arranged between a final robot link, in particular between what is known as the robot hand, and a processing tool (end effector) fastened thereto.

Furthermore, a respective motor 28 is associated with a current sensor 40B via which the momentary motor current of the motor 28 is detected. The current sensor 40B forms a second device for detecting the force acting on the respective robot link 22.

The individual drive units associated with a respective articulation 24 including the first and the second movement sensor (encoder 34A, 34B) and including the first and second devices (strain gauge 40A and current sensor 40B) are preferentially identical for all of the articulations 24.

Furthermore, two evaluation units 44A, 44B, or monitoring units 44A, 44B, are designed for monitoring. The first evaluation unit 44A receives the (measurement) data of all first encoders 34A and all strain gauges 40A. Based on this data, the first evaluation unit 44A carries out evaluation with regard to the momentary position and/or speed of the respective robot link 22 and in particular also with regard to the force momentarily acting on the robot link 22.

In analogy hereto, the second evaluation unit 44B receives the (measurement) data of all second encoders 34B and all current sensors 40B and performs the evaluation on the basis of this data in analogy to the first evaluation unit 44A.

In the variant according to FIG. 3, two separate data paths are formed within the articulation 24 represented by the box which in each case lead to an articulation-specific interface 46A, B. They are in particular data or communication interfaces which communicate with the two evaluation units 44A, 44B. More precisely, the first system components (first encoder 34A, first brake 64A, first device (strain gauge 40A)) are attached to the first interface 46A. By contrast, the second system components (second encoder 34B, second brake 64B, second device (current sensor 40B)) are attached to the second interface 46B.

Each interface 46A, 46B is furthermore attached to the evaluation unit 44A, 44B associated therewith. The two interfaces 46A, 46B and/or the two evaluation units 44A, B are preferentially attached to one another via a communication connection, in particular in order to compare the respective data to one another.

In an appropriate further development, data communication is in particular between the interfaces 46A, 46B and the evaluation units 44A, 44B via different bus systems 48A, 48B, in particular via a first bus system 48A designed as an Ethernet bus and a second bus system 48B designed as an RS-485 bus.

The first evaluation unit 44A along with the first movement sensor (first encoder 34A) and the first device (strain gauge 40A) and, in the variant according to FIG. 3, with the first interface 46A and the first bus system 48A form a first monitoring device. Correspondingly, the second evaluation unit 44B along with the second movement sensor (second encoder 34B) and the second device (current sensor 40B) and, in the variant according to FIG. 3, with the second interface 46B and the second bus system 48B form a second monitoring device.

This forms two redundant monitoring paths in total so that operationally reliable monitoring is ensured. It should be emphasized that in particular the individual sensor devices for the two monitoring paths are independent from one another and are in particular based on different measuring principles.

Furthermore, it should be emphasized that, as a higher-level design principle for safe operation of the articulated-arm robot 2, it has a redundantly adapted system with a plurality of system components which are therefore designed redundantly in relation to one another. Redundantly designed system components are in each case designed for carrying out the same function and in particular enable (further) operation of the articulated-arm robot 2if one of the two redundant system components fails.

Presently, the system components are the previously listed first components of the first monitoring device and the first brake 64B or the previously listed second components of the second monitoring device and the second brake 64B.

At least some, preferentially a plurality of and in particular all of these system components are designed differently in relation to one another, as has also already been explained previously.

In conjunction with FIG. 6, explained below is the redundantly adapted braking device 60 with the two brakes 64A, 64B which function according to distinct physical action principles:

The redundant braking device 60 is in each case designed as a part of a drive unit 62. The adjustment movement of a respective robot link 22 is exerted via a respective drive unit 62. In particular, the drive unit 62 is arranged immediately within an articulation 24.

The redundantly designed braking device 60 has the two brakes 64A, 64B which are in each case designed to exert a braking force currentlessly. The two brakes 64A, 64B and the generation of the braking force are based on different action principles.

In the represented embodiment, on a joint shaft 66, the drive unit 62 has the electric motor 28 and downstream thereof on an output side the transmission 30. A segment of the shaft 66 referred to as the output shaft 32 drives the robot link 22 and is attached thereto via a suitable, for example flexible, shaft attachment.

In the embodiment, the braking device 60 is arranged at a segment of the shaft 66 designed on the input side and hence opposing the output side.

Alternatively, according to a preferred variant, the braking device is arranged between the motor 28 and the transmission 30.

In the embodiment, the shaft 66 has a segment designed as a hollow shaft 72 to which the braking device 60 is fixed. The hollow shaft 72 is attached to the remainder of the shaft 66 in a suitable manner, for example via flanges.

At the center of the hollow shaft 72, it has a stationary brake disk 74 fixedly attached thereto. To both sides thereof, in each case one moving brake disk 76A, 76B is positioned which is mounted slidingly in a longitudinal direction of the hollow shaft 72.

Each of these moving brake disks 76A, 76B is in each case associated with one electromagnet 78A, 78B.

A currentless force acts on each of the moving brake disks 76A, 76B which is oriented in a direction towards the stationary brake disk 74. For the one moving brake disk 76A, this force is exerted by means of a spring element 80. For the other moving brake disk 76B, this force is exerted by means of a permanent magnet 82. For example, it is embedded with the moving brake disk 76B or forms a support with a brake pad arranged thereon.

The two electromagnets 78A, 78B, which may generate a counterforce to the spring force or the force of the permanent magnet in a controlled manner, serve to control the braking force.

The two electromagnets 78A, 78B are energized via electric lines 84. The electric lines 84 run within a cavity of the hollow shaft 72 towards the electromagnets 78A, 78B.

Furthermore, position sensors 86 are preferentially arranged which detect the respective position of the moving brake disk 76A, 76B in relation to the stationary brake disk 74. Dependent on these position sensors 86A, B, for example, the electromagnets 78A, 78B are energized.

Preferably, one respective moving brake disk 76A, 76B is in each case associated with two position sensors 86A, 86B. Preferably, these are designed not only redundantly but also differently as well. Especially, the position sensors 86 monitor an air gap between the moving brake disk 76A, 76B and the stationary brake disk 74. The two redundant position sensors 86A, B, which are in each case associated with one brake 64A, 64B, are preferentially designed so as to be opposed so that therefore the one sensor is closed while in the normal state and the other sensor is open while in the normal state.

The following is a summary list of reference numerals and the corresponding structure used in the above description of the invention:

20 articulated-arm robot

22 robot link

24 articulation, joint

26 pedestal

28 motor

30 transmission

32 output shaft

34A first encoder

34B second encoder

38 tool

40A strain gauge, force detector

40B current sensor, force detector

42 readings recorder

44A first evaluation unit

44B second evaluation unit

46A first interface

46B second interface

48A first bus system

48B second bus system

60 braking device

62 drive unit

64A, B brake

66 shaft

72 hollow shaft

74 stationary brake disk

76A, B moving brake disk

78A, B electromagnet

80 spring element

82 permanent magnet

84 line

86A, B position sensors

1. An articulated-arm robot (20), comprising:
a plurality of robot links attached to one another by respective articulations and each driven by an electric motor;
two independent monitoring devices for redundant monitoring of a robot operation, including a first monitoring device and a second monitoring device;
each of said first and second monitoring devices having:
a movement sensor, being a first movement sensor and a second movement sensor respectively, for detecting a momentary position of a respective said robot link;
a force detector configured for detecting a force momentarily acting on the respective said robot link, being a first force detector and a second force detector, respectively, and said first and second force detector operating on mutually different measuring principles; and
an evaluation unit, being a first evaluation unit for processing data of said first movement sensor and data of said first force detector and a second evaluation unit for processing data of said second movement sensor and data of said second force detector.

2. The articulated-arm robot according to claim 1, wherein a respective said evaluation unit is configured to collectively evaluate, and to reciprocally verify, data momentarily detected via the respective said movement sensor and data momentarily detected via the respective said force detector on the acting force with regard to any potential collision of the articulated-arm robot with an object.

3. The articulated-arm robot according to claim 1, wherein said force detector for detecting the momentary force associated with said first monitoring device includes at least one strain gauge affixed to said robot link or an alternatively designed force measuring device.

4. The articulated-arm robot according to claim 3, wherein said force detector for detecting the momentary force associated with said second monitoring device includes a current sensor for determining a motor current of said electric motor.

5. The articulated-arm robot according to claim 1, wherein each of said first and second movement sensors is an encoder for detecting a rotational movement of a shaft of said motor.

6. The articulated-arm robot according to claim 1, wherein said first and second movement sensors are arranged at different locations.

7. The articulated-arm robot according to claim 1, wherein said first and second movement sensors are designed differently.

8. The articulated-arm robot according to claim 1, wherein one of said movement sensors is an incremental encoder and another of said movement sensors is an absolute encoder, and/or said first and second encoders differ with regard to the number of reading heads.

9. The articulated-arm robot according to claim 1, wherein a plurality of said robot links are associated with a respective first and second movement sensor and a first and a second force detector, and wherein data of all said first movement sensors and said first force detectors is evaluated by said first evaluation unit and data of all said second movement sensors and said second force detectors is evaluated by said second evaluation unit.

10. The articulated-arm robot according to claim 9, wherein all of said robot links are associated with a respective first and second movement sensor and a first and a second force detector.

11. The articulated-arm robot according to claim 1, wherein said first and second evaluation units are designed differently.

12. The articulated-arm robot according to claim 1, wherein data communication with said first and second evaluation units is connected via different bus systems.

13. The articulated-arm robot according to claim 1, wherein said robot links are driven via electric drive units each having one said electric motor, wherein at least one of said drive units has a redundant braking device with two brakes that are each designed for exerting a currentless braking force, and wherein said two brakes are based on different action principles so that the respective braking force of said two brakes is exerted by distinct action principles.

14. A method for monitoring a multi-axis articulated-arm robot having a plurality of robot links which are attached to one another by respective articulation joints and are each driven by an electric motor, the method comprising:
providing a first monitoring device and a second monitoring device, each having a movement sensor for detecting a momentary position of a respective robot link;
providing a first and a second force detector for detecting a force momentarily acting on the robot link, wherein the first and second devices are based on different measuring principles and measuring the force momentarily acting on the robot link via the two devices;
evaluating by a first evaluation unit the data of the first movement sensor and the data of the first force detector and by a second evaluation unit the data of the second movement sensor and the data of the second force detector.

15. The method according to claim 14, wherein said first and second force detectors are based on different measuring principles and measure a deformation via the two devices.

16. The articulated-arm robot according to claim 1, comprising a redundantly adapted system for operating the articulated-arm robot, wherein each redundant system has a plurality of system components with at least one system component of the two redundant systems being designed differently.

17. The articulated-arm robot according to claim 16, wherein said differently designed system components are based on different action principles.

18. The articulated-arm robot according to claim 16, wherein the respective said redundant system has a control unit and/or evaluation unit, and wherein the control units and/or evaluation units of said two redundant systems are different from one another and originate from distinct manufacturers.

19. The articulated-arm robot according to claim 16, wherein in each case a plurality of system components, or all of the system components of the two redundant systems are different from one another.

20. The articulated-arm robot according to claim 16, wherein the system components include one or more or all of the following components:
a. a redundantly adapted braking device with two brakes which are based on different action principles;
b. redundant monitoring of the operation of the articulated-arm robot with two monitoring devices which differ from one another;
c. different control or evaluation units;
d. differently designed movement sensors for detecting a momentary position of the respective robot link;
e. different devices for detecting a force momentarily acting on the robot link;
f. different position sensors for detecting positions of parts of a braking device; and
g. different bus systems for data transmission.
